(19) United States
(12) Patent Application Publication
(10) Pub. No.: US 2015/0234420 A1
(43) Pub. Date: Aug. 20, 2015

(54) Clock Switching Circuit

(71) Applicant: ENERGY PASS INCORPORATION, Hsinchu City (TW)

(72) Inventor: Ming-Wei Lin, Hsinchu City (TW)

(73) Assignee: ENERGY PASS INCORPORATION, Hsinchu City (TW)

(21) Appl. No.: 14/183,499

(22) Filed: Feb. 18, 2014

(51) Int. Cl. G06F 1/08

(52) U.S. Cl. CPC G06F 1/08

(57) ABSTRACT

A clock switching circuit for an analog-to-digital converter includes a plurality of clock sources for generating a plurality of clock signals, a plurality of fail-detecting units, coupled to the plurality of clock sources, for generating a plurality of detecting results, and a priority selecting and switching circuit, for selecting and switching one of the plurality of the clock sources as an input clock of the analog-to-digital according to the plurality of detecting results.

### BACKGROUND OF THE INVENTION

1. Field of the Invention

The present invention relates to a clock switching circuit, and more particularly, to a clock switching circuit for switching clock signals when detecting clock failure to achieve clock fail-save.

2. Description of the Prior Art

Some battery monitoring devices feature a coulomb counter to measure charge and discharge currents in smart batteries. Such a coulomb counter often cooperates with an analog-to-digital converter (ADC) to record sampling currents on the battery. Then, a consumed power of the battery is computed via integrating the recorded sampling currents, such that the battery monitoring device provides the state of charge and other information of the battery.

Since the ADC requires an input clock signal as a sampling rate for converting the recorded analog sampling currents into digital data, the state of charge and other information of the battery can be translated correctly. If the input clock signal of the ADC fails or stops, the battery monitoring device may stop or provide incorrect information of the battery.

Thus, a traditional ADC for the battery monitoring devices adds an input clock fail detecting unit for detecting whether the input clock of the ADC works normally. The fail detecting unit generates a detecting signal to indicate the input clock of the ADC fails, so as to initiate a repair or a replacement of the ADC.

However, a battery motivated car requires higher functional reliability of the battery monitoring device. Constantly monitoring a battery capacity of the car is to avoid that the car uses up electricity and stops suddenly on the road, which avoids traffic accident. A fail-save mechanism is therefore significant for the battery monitoring device. Thus, there is a need to improve the prior art to achieve clock fail-save and increase the functional reliability of the ADC.

### SUMMARY OF THE INVENTION

It is therefore an object to provide a clock switching circuit for switching clock when detected clock failure.

The present invention discloses a clock switching circuit, for an analog-to-digital converter, including a plurality of clock sources for generating a plurality of clock signals, a plurality of fail-detecting units, coupled to the plurality of clock sources, for generating a plurality of detecting results, and a priority selecting and switching circuit, for selecting and switching one of the plurality of the clock sources as an input clock of the analog-to-digital converter according to the plurality of detecting results.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a clock switching circuit according to an embodiment of the present invention.

FIG. 2 is a schematic diagram of the fail-detecting unit shown in FIG. 1 according an embodiment of the present invention.

### DETAILED DESCRIPTION

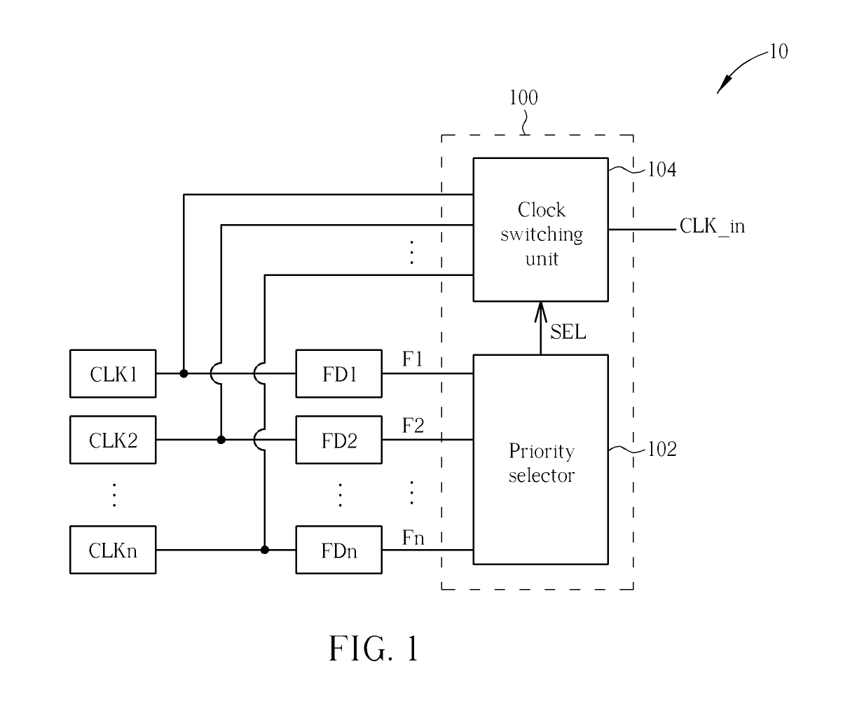

Please refer to FIG. 1, which is a schematic diagram of a clock switching circuit 10 according to an embodiment of the present invention. The clock switching circuit 10 provides an input clock signal CLK_in for an integrated circuit (IC), such as an analog-to-digital converter (ADC), a micro controller or a processor. The clock switching circuit 10 includes clock sources CLK1-CLKn, fail-detecting units FD1-FDn and a priority selecting and switching circuit 100. The clock sources CLK1-CLKn generate clock signals, wherein clock frequencies of the clock signals could be totally unrelated to each other or a same frequency, or they may be multiples of each other. Each of the fail-detecting units FD1-FDn are coupled to one of the clock sources CLK1-CLKn, for detecting whether the clock signals generated by the clock sources CLK1-CLKn are failed or stopped, e.g. transmit a high/low level voltages or incorrect clock frequency, so as to generate detecting results F1-Fn. The priority selecting and switching circuit 100 selects and switches one of the clock signals of the clock sources CLK1-CLKn as an input clock signal CLK_in of the IC according to the detecting results F1-Fn.

In other words, the clock sources CLK1-CLKn provide multiple clock signals with same or different clock frequencies, and the priority selecting and switching circuit 100 selects and switches one of the clock sources CLK1-CLKn as an input clock signal CLK_in of the IC according to the detecting results F1-Fn generated by the fail-detecting units FD1-FDn. As a result, once the input clock signal CLK_in of the IC fails, the clock switching circuit 10 switches another clock source as a replacement for the failed input clock signal CLK_in, which achieves clock fail-save and improves a functional reliability of the IC.

More specifically, the priority selecting and switching circuit 100 further includes a priority selector 102 and a clock switching unit 104. Since a glitch could be hazardous when the IC is running, the clock switching unit 104 is preferably a glitch-free clock switching unit. The priority selector 102 receives the detecting results F1-Fn generated by the fail-detecting units FD1-FDn, and computes a priority over the clock sources CLK1-CLKn according to the detecting results F1-Fn, so as to output a selecting signal SEL to the clock switching unit 104. The clock switching unit 104 is further coupled to the clock sources CLK1-CLKn, and switches one of the clock signals of the clock sources CLK1-CLKn with a highest priority as the input clock signal CLK_in of the IC according to the selecting signal SEL. In such a situation, the IC may have the sustainable input clock signal CLK_in to stay operative.

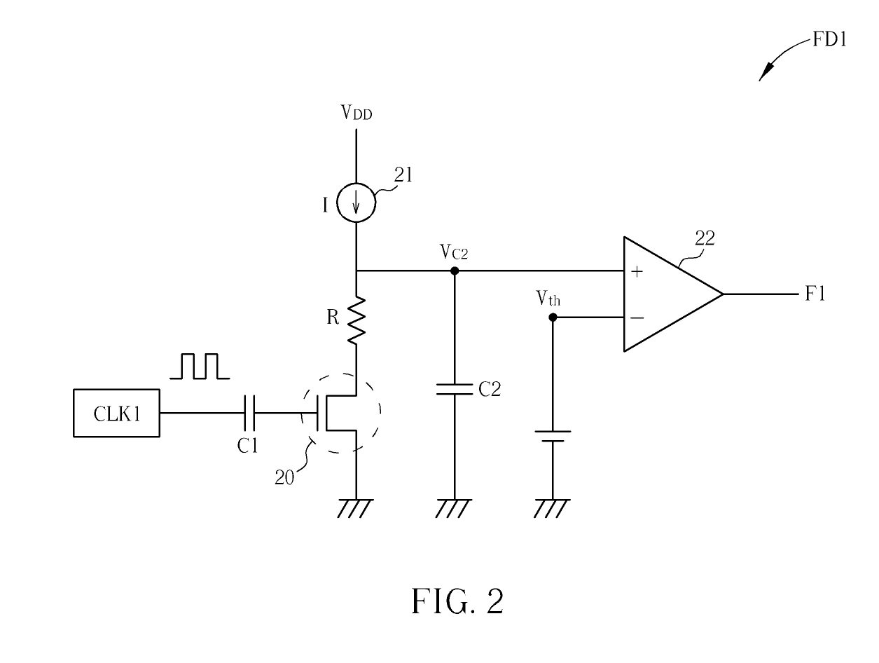

Noticeably, please refer to FIG. 2, which is a schematic diagram of the fail-detecting unit FD1 shown in FIG. 1 according an embodiment of the present invention. As shown in FIG. 2, a capacitor C1 is coupled between the clock source CLK1 and a gate of a transistor 20, for turning the transistor 20 on/off . A positive terminal of a comparator 21 is connected to a current source 22, a capacitor C2 and a resistor with a resistance R, a negative terminal of the comparator 21 is connected to a voltage source with a threshold voltage Vₜₕ.

In such an arrangement, when the clock source CLK1 keeps transmitting a clock signal, the capacitor C1 passes the clock signal to turn on the transistor 20, and thus a current I generated by the current source 22 flows through the resistor and the transistor 20. A voltage V_{C2} at a positive terminal of a comparator 21 is I*R, which is assumed to be less than the threshold voltage Vₜₕ, such that the comparator 21 outputs the detecting result F1 with a high voltage level. On the other hand, when the clock source CLK1 fails, e.g. transmits a high/low level voltage, the capacitor C1 blocks the clock signal to turn off the transistor 20, and thus the current I does not flow through the resistor and the transistor 20. The current I charges the capacitor C2 until the V_{C2} equals a system voltage V_{DD}, which is assumed to be greater than the threshold voltage Vₜₕ, such that the comparator 21 outputs the detecting result F1 with a low voltage level. As a result, the fail-detecting unit FD1 outputs the detecting result F1 at a high/low level to perform clock fail-detection.

According to above description, the clock switching circuit 10 of the present invention utilizes the fail-detecting units FD1-FDn to detect whether the clock sources CLK1-CLKn are failed, and switches one of the clock signals of the clock sources CLK1-CLKn as the input clock signal CLK_in of the IC through the priority selecting and switching circuit 100, so as to achieve clock fail-save and improve a functional reliability of the IC. Those skilled in the art should make modifications and alterations accordingly. For example, the clock switching circuit 10 may perform switching to provide a clock signal to multiple ICs, or provide multiple clock signals to multiple ICs. And the priority selector 102 of the priority selecting and switching circuit 100 may further connect to the IC for adding a priority selecting condition from the IC. In other words, the IC may transmit a priority selecting signal to the priority selector 102 according to an operating performance of the IC, e.g. increase or decrease clock frequencies. In such a situation, the priority selector 102 generates the selecting signal SEL according to the detecting results F1-Fn and the priority selecting condition from the IC. Therefore, the clock switching circuit 10 is more flexible for clock priority computation.

To sum up, the prior art performs clock fail-detection on the traditional IC, e.g. an ADC, to indicate a clock failure. While the present invention not only utilizes the fail-detecting units to detect whether the clock signals are failed, but also switches one of the clock signals as the input clock of the IC through the priority selecting and switching circuit, so as to achieve clock fail-save and improve a functional reliability of the IC.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A clock switching circuit, for an analog-to-digital converter (ADC), comprising:
a plurality of clock sources, for generating a plurality clock signals;
a plurality of fail-detecting units, coupled to the plurality of clock sources, for generating a plurality of detecting results according to the plurality clock signals; and
a priority selecting and switching circuit, for selecting and switching one of the plurality of clock signals as an input clock signal of the ADC according to the plurality of detecting results.

2. The clock switching circuit of claim 1, wherein the priority selecting and switching circuit comprises:
a priority selector, for generating a selection signal according to the plurality of detecting results; and
a clock switching circuit, for switching one of the plurality of clock signals according to the selection signal, to output the output clock.

3. The clock switching circuit of claim 2, wherein the clock switching circuit is a glitch-free switching circuit.

4. The clock switching circuit of claim 1, wherein the plurality of fail-detecting units detect whether the plurality of the clock signals are failed to generate the plurality of detecting results.

5. The clock switching circuit of claim 3, wherein each of the plurality of fail-detecting units comprises:
a current source, coupled to a system voltage;
a first capacitor, coupled to one of the plurality of clock sources;
a transistor, with a gate coupled to the first capacitor, and a source coupled to a ground;
a resistor, coupled between the current source and a drain of the transistor;
a second capacitor, coupled between the current source and the ground;
a reference voltage source, for providing a reference voltage; and
a comparator, for comparing a voltage on the second capacitor with the reference voltage, to output the detecting result.

6. The clock switching circuit of claim 5, wherein the transistor is turned on via the first capacitor when the clock source transmits a clock signal.

7. The clock switching circuit of claim 5, wherein the transistor is turned off via the first capacitor when the clock source transmits a high level voltage and a low level voltage.
